(19) United States
(12) Patent Application Publication
(10) Pub. No.: US 2024/0144285 A1
(43) Pub. Date: May 2, 2024

(54) SYSTEMS AND METHODS FOR GENERATING A DYNAMIC CVV AND/OR PIN

(71) Applicants: Asher YAHALOM, Givaat Shmuel (IL); Amir POZNANSKY, Tel Aviv (IL)

(72) Inventors: Asher YAHALOM, Givaat Shmuel (IL); Amir POZNANSKY, Tel Aviv (IL)

(21) Appl. No.: 18/280,821

(22) PCT Filed: Mar. 8, 2022
(86) PCT No.: PCT/IL2022/050261

§ 371 Date: Sep. 7, 2023

Related U.S. Application Data
(60) Provisional application No. 63/157,841, filed on Mar. 8, 2021.

(51) Int. Cl. G06Q 20/40; G06Q 20/32

(52) U.S. Cl. CPC G06Q 20/4018; G06Q 20/3223; G06Q 20/4012

(57) ABSTRACT

A system and method for generating a dynamic Card Verification Value (CVV) code or Personal Identification Number (PIN) code. When a user wishes to perform a financial transaction with a merchant, a mobile application associated with a transaction card generates a dynamic CVV or PIN based on a timestamp, a fixed code and personal user data. The user supplies the received, dynamic CVV or PIN to the merchant. The merchant sends a transaction record of the financial transaction to a clearing server of a financial institute associated with the transaction card. An authentication module within the clearing server, verifies and authenticates the dynamic CVV or PIN and replaces it with the original, fixed CVV or PIN for validation of the financial transaction.

### TECHNICAL FIELD

The present invention relates to systems and methods for generating dynamic Card Verification Value (CVV) and/or Personal Identification Number (PIN) codes in general, and in particular to providing a compressed and encrypted transmissions of a CVV and/or a PIN.

### BACKGROUND ART

Magnetic cards, and in particular commercial credit cards, have been in use in commerce for over 50 years. Transactions cards are a very popular mean in order to identify a person or an account. Transaction cards are used for a variety of applications from financial transactions to registering presence to library cards. Financial transactions in the form of credit cards are probably one of the most popular uses of transactions cards today. These financial transactions include debit and credit card (which will be both referenced herein as “credit cards”), which are typically used for retail purchases, online purchases and cash retrieval at Automatic Teller Machines (ATM's).

Financial transactions via credit cards are very popular since they offer several advantages for both users and merchants. Users do not need to carry large amounts of cash on them in order to purchase goods or services. In addition, some cards offer the user, the possibility of deferring some or all of the payments for the goods or services purchased thus offering accessible (though not always cheap) credit services.

Credit cards offer several advantages to merchants, for example, not holding or accumulating large amounts of cash in the business (cash that can be lost, stolen, robbed and that needs secured delivery for deposit), guarantee of payments by the card issuer as opposed to personal checks that may not be honored. In addition, credit cards are an excellent tool to accept payment remotely from a user either on the Internet or over the telephone.

As credit cards become such a popular tool for payment, fighting credit card fraud has become a major issue for financial institutions and merchants. Credit card frauds can be categorized into two types of fraud: one where a genuine card is stolen or lost and arrives to the hands of an unauthorized user; the other type being when the information regarding a credit card arrives to an unauthorized user which uses this data to purchase goods or services online or alternatively manages to manufacture a duplicate credit card which is then used in retail and cash retrieval.

More and more credit card transactions are performed nowadays remotely either over the Internet, telephone, fax or mail or any online service. These types of transactions are known as “Card Not Present (CNP) transactions” wherein the merchant does not see the actual credit card. The Personal Identification Number (PIN) code of the credit card is never used or requested in these remote transactions.

In order to improve the security of credit card retail transactions an additional 3- or 4-digit number known as Card Security Code (CSC) has been introduced and written on the card or signature stripe. The code known as Card Validation Code (CVC1) or Card Validation Value (CVV1) is intended for transactions in person and is encoded on the magnetic stripe. In contrary, other types of CSC are not encoded on the magnetic stripe and are used for remote transactions such as over the telephone, Internet, by mail or by fax or any other remote method. Those types of CSC are also known as Card Verification Value (CVV or CVV2), Card Verification Value Code (CVVC), Card Verification Code (CVC), Verification Code (V-Code or V Code), or Card Code Verification (CCV). Supplying the CSC code in a transaction is intended to verify that the customer has the card in his possession. Knowledge of the code proves that the customer has seen the card, or has seen a record made by somebody who saw the card.

One great concern is that the CVV number can fall into an unauthorized user who either has seen the card or has processed a legitimate transaction of the card. This unauthorized user can thus present this CVV in remote, fraudulent transactions.

There is thus an ongoing need, with great financial implications, to provide credit cards that include improved security features for CNP transactions.

### SUMMARY OF INVENTION

The present invention relates to a computing system comprising at least one processor; and at least one memory communicatively coupled to the at least one processor comprising computer-readable instructions that when executed by the at least one processor cause the computing system to implement a method of generating a dynamic Card Verification Value (CVV) code for a transaction card, the method comprising:
(i) receiving a timestamp;
(ii) receiving an initial code and personal data related to said transaction card and/or the user of said transaction card;
(iii) calculating a secret key based on a predefined formula receiving as input the initial code, timestamp and personal data;
(iv) performing a first statistical manipulation on the secret key based on the digits of the secret key (alphabet), the probability of occurrence of each digit in the secret key, the digits of the initial code and reordering the alphabet accordingly;
(v) performing a second statistical manipulation based on selecting a digit from the alphabet and partitioning an interval of the value of said digit, to sub-intervals based on the probabilities of occurrence of the digits in the reordered alphabet;
(vi) performing a third statistical manipulation based on selecting a digit from the alphabet and partitioning the corresponding interval of said digit previously calculated, to sub-intervals based on the probabilities of occurrence of the digits in the reordered alphabet;
(vii) repeating step (vi) for a predetermined number of times; and
(viii) selecting a number from the last calculated interval as the dynamic CVV code.

In some embodiments, the computing system is implemented on a mobile telephone.

In some embodiments, the computing system is implemented on a personal computer.

In some embodiments, the initial code is the transaction card's static CVV code.

In some embodiments, the timestamp has 16 digits.

In some embodiments, the dynamic CVV is any number in the last calculated interval.

In some embodiments, the dynamic CVV is a predefined number in the last calculated interval (i.e. first, last, half, X %, random).

In some embodiments, step (vi) is repeated in correlation with the number of digits in the initial code.

In some embodiments, the computing system further comprises the step of sending an authentication server the generated CVV and the timestamp, so the authentication can perform the same calculation as in Claim 1 to authenticate the dynamic CVV.

In another aspect, the present invention relates to a computing system comprising at least one processor; and at least one memory communicatively coupled to the at least one processor comprising computer-readable instructions that when executed by the at least one processor cause the computing system to implement a method of generating a dynamic Card Verification Value (CVV) code for a transaction card, the method comprising:
(i) receiving a timestamp;
(ii) receiving an initial code and personal data related to said transaction card and/or the user of said transaction card;
(iii) calculating a secret key based on a predefined formula receiving as input the initial code, timestamp and personal data;
(iv) performing a first statistical manipulation on the secret key based on the digits of the secret key (alphabet), the probability of occurrence of each digit in the secret key, the digits of the initial code and reordering the alphabet accordingly;
(v) performing a second statistical manipulation based on selecting a digit from the alphabet and partitioning an interval of the value of said digit, to sub-intervals based on the probabilities of occurrence of the digits in the reordered alphabet;
(vi) performing a third statistical manipulation based on selecting a digit from the alphabet and partitioning the corresponding interval of said digit previously calculated, to sub-intervals based on the probabilities of occurrence of the digits in the reordered alphabet;
(vii) repeating step (vi) for a predetermined amount of times; and
(viii) selecting a number from the last calculated interval as the dynamic CVV code;
(ix) sending the timestamp and dynamic CVV code to an authentication server; and
(x) having the authentication server calculate independently a server dynamic CVV based the received timestamp, personal data, and authenticate the received dynamic CVV only if matching the received dynamic CVV.

### BRIEF DESCRIPTION OF DRAWINGS

FIG. 1 is a schematic view of the repeated partition process for as shown in example 1.

FIG. 2 is a block diagram of an architecture to provide a dynamic CVV or PIN.

### MODES FOR CARRYING OUT THE INVENTION

In the following detailed description of various embodiments, reference is made to the accompanying drawings that form a part thereof, and in which are shown by way of illustration specific embodiments in which the invention may be practiced. It is understood that other embodiments may be utilized, and structural changes may be made without departing from the scope of the present invention.

The present invention relates to a computing system comprising at least one processor; and at least one non-transient memory communicatively coupled to the at least one processor comprising computer-readable instructions that when executed by the at least one processor cause the computing system to implement a method of generating a dynamic Card Verification Value (CVV) code for a transaction card.

Additionally, or alternatively, the method may also be used to generate a dynamic Personal Identification Number (PIN) for the transaction card.

The transaction card can be any type of a transaction card requiring a code for authentication, for example, any type of financial card such as a credit or debit card.

The method comprises several steps. Initially 3 parameters are received, a timestamp, a fixed code and one or more personal data:
(i) A timestamp, for example, combining the year, month, day, hour, minutes and seconds. An example of a timestamp with a precision of 16 digits YYYYMMDDHHMMSSSS can be “2021013114335256” for Jan. 31, 2021 at 14 hours, 33 minutes, and 52.56 seconds. Naturally, any other variation on the time stamp (fields, precision, length etc.) can be used.
(ii) An initial code and personal data related to said transaction card and/or the user of said transaction card. The initial code can be any code, for example, a transaction card's (fixed) CVV number, assigned PIN, or any other assigned number. In addition, some personal data is received about the user which can be a combination of any fields, for example, social security number, date of birth, driving license number, date of issue of driving license, telephone number, postal code etc.

Next, a secret key is calculated based on a predefined formula receiving as input the initial code, timestamp and personal data. The secret-key is used as an input to a statistical/arithmetical model in order to generate a valid Dynamic CVV or dynamic PIN. The dynamic CVV or PIN is generated by integrating the secret key in a specified adaptive coding scheme, and encoding a predefined initial code, such as a static CVV/PIN code. Adaptive coding schemes are disclosed, for example, in “I. H. Witten and J. G. Cleary. On the privacy afforded by adaptive text compression. Comput. Secur., 7(4):397-408, August 1988” integrated herein by reference.

The output of the method is a dynamic CVV or PIN, which, for security reasons, can be activated only for a predefined duration, for example, one minute, three minutes etc. In some embodiments, a secret-key can be utilized to produce more than a single dynamic CVV or PIN code.

As disclosed in Algorithm 1, the model for the encoding is initialized according to a function f, that operates on the digits of a given timestamp (can be 16 decimal digits or any other size) together with given personal data. The alphabet as well as their corresponding sub-intervals within the initial interval [0,1) are determined according to the outcome of the function f. The order of the sub-intervals can optionally also be updated in the following stages of the algorithm. If compression is not of main concern, the weights of the alphabet symbols may also be computed according to the secret key. Otherwise, the weights are based on the probability distribution of the alphabet.

Algorithm 1: Crypto-CVV Encoding

```
Input:
  static CVV abc
  time-stamp
  data
Output:
  x − Random-CVV
Crypto-CVV-Encoding(abc, time-stamp; data) {
  1 str = s₁ ... sₙ f(abc; time-stamp; data)
  2 initialize the model based on abc; time-stamp; data
  3 [low; high) [0; 1)
  4 for i 1 to n do
    5 update [low; high) according to the weight of si
    6 (optionally) use abc; time-stamp; data to update the model
  7 return a random number x in the final range [low; high)
}
```

Traditional static arithmetic coding initializes an interval [low; high) by [0; 1), and computes the following sub-intervals according to a probability calculated for each of the symbols based on the frequency distribution of the entire alphabet. As processing the message left to right, the current interval gets narrowed to the subinterval corresponding to the probability of the processed symbol. The encoding of the message is any value in the final interval obtained after processing the entire massage. While the probability distribution assigned to the model is fixed throughout the process for static arithmetic coding, the adaptive arithmetic variant computes the probability of the current symbol based on the number of its appearances in the already processed portion of the message.

Algorithm 1 presents a pseudo-code for generating a random dynamic CVV. The input is a given static CVV code, a certain timestamp and personal data, denoted by abc, time-stamp and data, respectively. The input string abc is a string of length 3 composed of the individual digits of a given static CVV code, alternatively any other predefined code of any length can also be used. The input timestamp is obtained at some point of the transition, e.g., the time the transition is initiated. The data can be any information concerning the transaction/credit card user, e.g., his social number in this example. The secret-key variable, computed on Line 1, combines the input time-stamp and personal data to obtain the secret-key used in the following steps of the algorithm. The secret-key is also a function of data so that to produce different keys for transactions with exactly the same time-stamp. The model is initialized on Line 2 by determining the alphabet, the order of its symbols, and possibly the initial symbols' weights in case compression is not of main concern, as stated above. As for standard arithmetic coding, the initial interval is [0; 1), assigned to [low; high) on Line 3. The symbols of str=s₁ . . . sₙ are processed left to right. Each symbol sᵢ narrows the current interval to a new interval [low; high) of size proportional to the weight distribution of sᵢ and location within the current interval according to the secret key. The process continues until the last interval is computed according to sₙ, the last character of str. Then, any real number within the final interval can be set as the desired output as shown on Line 7. Alternatively, additional updates of the model can be applied during the process of str, as presented on Line 6.

The Authorization process, Crypto-CVV-Authorization, is presented in Algorithm 2. The input is the same secret key followed by the encrypted dynamic CVV. The Boolean output indicates whether the transaction is authorized or not.

Algorithm 2: Crypto-CVV-Authorization

Input:

```
    static CVV abc
    time-stamp
    data
```

Output:

true or false depending on whether transaction is authorized

Crypto-CVV-Authorization (x; time-stamp; data) {

| | |
|---|---|
| 1 | initialize the model based on abc; time-stamp; data |
| 2 | [low; high) [0; 1) |
| 3 | str ← ε |
| 4 | While (not EOF) |
| 5 | Find symbol sᵢ whose range contains x |
| 6 | str = str * sᵢ |
| 7 | update [low; high) according to the weight of si |
| 8 | (optionally) use abc; time-stamp; data to update the model |
| 9 | if str ≠ f (abc; time-stamp; data) then |
| 10 | return false |
| 11 | else |
| 12 | return true |

}

### Example 1—Generating a Dynamic CVV

For example, assume the initial code is 613 (CVV), the time is Oct. 29, 2020 at 12:34:56.78, represented by 2020:10:29:12:34:56:78, and SSN is 929-39-5780. Let

f(abc;Y Y Y Y:MM:DD:Thh:mm:ss:sTZD;AAA-GG-SSSS)=a*(Y Y Y YMMDD)+b*hhmmsssTZD+c*AAAGGSSSS:

That is, where f is a linear combination of some decimal numbers obtained from a partial or complete set of digits of Time and SSN. In our case,

str=f(613,2020:10:29:12:34:56:78;929-39-5780)=6*(20,201,029)+1*12,345,678+3*929,395,780=2,921,739,192:

The alphabet is {1; 2; 3; 7; 9} with probabilities, {2/10, 3/10, 1/10, 1/10, 3/10}, respectively. The order of the symbols within the intervals may be determined according to the input, e.g., by CVV that could define the number of skips between the alphabet symbols in a cyclic manner, eliminating those that have been chosen. In our running example with CVV=613, skipping 6 characters cyclically on an alphabet of size 5, 1
becomes the first symbol of Σ. Skipping 1 character, the second is 2, and skipping 3 characters, the third is 9. Skipping again 6, 7 is the fourth symbol, leaving 3 to be the last, that is, the ordered alphabet set is Σ={1, 2, 9, 7, 3} with probabilities {2/10, 3/10, 3/10, 1/10, 1/10}, respectively.

The initial interval [0,1) is partitioned into 5 sub-intervals according to their corresponding probabilities [0, 2/10), [2/10, 5/10), [5/10, 8/10); [8/10, 9/10), [9/10, 1). The first symbol to be processed in 2, corresponding to the interval [1/5, 5/10). The frequency of 2 is increased by 1, and the ordered set of probabilities corresponding to Y becomes {2/11, 4/11, 3/11, 1/11, 1/11}. The interval [2/10, 5/10) is then partitioned proportionally according to the updated set of probabilities. The size of the current range is 5/10-2/10=3/10. That is, the new intervals are [2/10, 28/110), [28/110, 40/110), [40/110, 49/110), [49/110, 52/110), [52/110, 5/10).

The following symbol is 9 and the current interval after processing 9 is [40/110, 49/110).

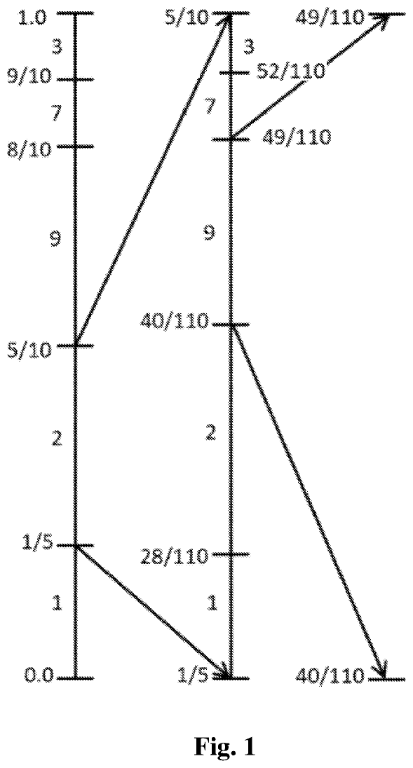

FIG. 1 is a schematic view of these repeated partition process for the beginning of this example. In subsequent steps, the same procedure is applied after appropriate scaling as shown in Table 1. The first column presents the current symbol of str, and the following two columns show the low and high bounds of the resulting interval. The final range is [0.38115933,0.38115939) and any number within this range can be used, e.g. 0.38115934. The final number is chosen randomly in order to resist a Chosen Plaintext Attack (CPA).

TABLE 1
The shrinking intervals for the example str = 2,921,739,192

| symbol | low | high |
|---|---|---|
| | 0.0 | 1.0 |
| 2 | 0.2 | 0.5 |
| 9 | 0.36363 | 0.4454545 |
| 2 | 0.3772727 | 0.404545 |
| 1 | 0.3772727 | 0.3814685 |
| 7 | 0.3808691 | 0.3811688 |
| 3 | 0.3811489 | 0.3811688 |
| 9 | 0.3811588 | 0.3811638 |
| 1 | 0.3811588 | 0.3811597 |
| 9 | 0.38115928 | 0.3811595 |
| 2 | 0.38115933 | 0.38115939 |

In another aspect, the present invention relates to a computing system comprising at least one processor; and at least one memory communicatively coupled to the at least one processor comprising computer-readable instructions that when executed by the at least one processor cause the computing system to implement a method of generating a dynamic Card Verification Value (CVV) code for a transaction card, the method comprising:
(i) receiving a timestamp;
(ii) receiving an initial code and personal data related to said transaction card and/or the user of said transaction card;
(iii) calculating a secret key based on a predefined formula receiving as input the initial code, timestamp and personal data;
(iv) performing a first statistical manipulation on the secret key based on the digits of the secret key (alphabet), the probability of occurrence of each digit in the secret key, the digits of the initial code and reordering the alphabet accordingly;
(v) performing a second statistical manipulation based on selecting a digit from the alphabet and partitioning an interval of the value of said digit, to sub-intervals based on the probabilities of occurrence of the digits in the reordered alphabet;
(vi) performing a third statistical manipulation based on selecting a digit from the alphabet and partitioning the corresponding interval of said digit previously calculated, to sub-intervals based on the probabilities of occurrence of the digits in the reordered alphabet;
(vii) repeating step (vi) for a predetermined number of times; and
(viii) selecting a number from the last calculated interval as the dynamic CVV code;
(ix) sending the timestamp and dynamic CVV code to an authentication server; and
(x) having the authentication server calculate independently a server dynamic CVV based the received timestamp and personal data, and authenticate the received dynamic CVV only if matching the received dynamic CVV.

The authentication server performs the same calculation based on the timestamp, personal data and initial code. The personal data and initial code can be stored at the authentication server (or be accessible by the authentication server) and only the timestamp needs to be transmitted to the authentication server in order to validate the received dynamic CVV. As the authentication server performs the same calculations, it will also reach the same final interval and will now the procedure to select a dynamic CVV from the interval. If the procedure is a predefined position, i.e. selecting the first number of the interval, the last number, the number in the middle, the number in position X (i.e. position 0.35 of the interval) then the authentication server will calculate the dynamic CVV and compare it to the dynamic CVV received. If the procedure is to select a random number in the final interval as a dynamic CVV, then the authentication server will simply verify that the received dynamic CVV is a value within the final interval calculated.

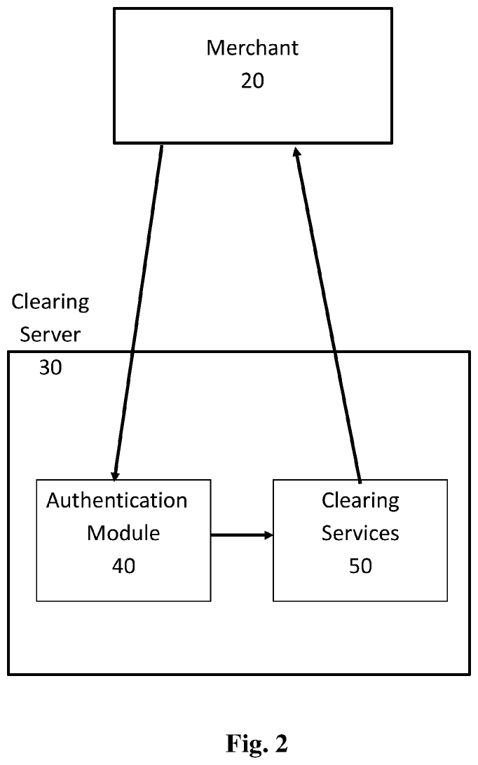

Reference is now made to FIG. 2 showing a block diagram of an architecture of a solution to provide a dynamic CVV or PIN. When a user of a transaction card wishes to perform a transaction with a merchant 20, the user consults his personal application of the invention, and provides the merchant 20 with a dynamic CVV issued by the application of the invention.

The merchant 20 then sends a transaction record of the financial transaction including the dynamic CVV received to the clearing server 30 of the financial institute associated with the transaction card. In the clearing server 30, the transaction record is received by an authentication module 40 of the invention that authenticates the dynamic CVV received. After validation of the dynamic CVV received, the authentication module 40 sends the transaction record to a clearing services module 50 after replacing the dynamic CVV with the original CVV associated with the transaction card.

The clearing services module 50 thus receives a transaction record for confirmation without being aware that the CVV has been swapped by the authentication module 40.

Technically, the authentication module 40 can be implemented in various ways, including but not limited to: a separate process within the clearing server 30; a separate server coupled to the clearing server 30; a remote server in communication with clearing server 30; fully integrated with the clearing server 30 etc.

It is preferred to send the entire transaction record to the authentication module 40 who then authenticates the dynamic CVV, replaces it with the fixed (original) CVV, and sends the financial transaction with the original CVV to the clearing services module 50. In this way, the clearing services module 50 does not need to be altered when working with a dynamic CVV since it only looks to validate the original (fixed) CVV.

Alternatively, the services module 50 may receive the transaction record with the dynamic CVV and then send the dynamic CVV to the authentication module 40 for authentication. Another alternative is to implement the entire functionalities of the authentication module 40 within the services module 50.

The same configuration disclosed in FIG. 2 can be used to generate a dynamic PIN, wherein the merchant 20 represents a financial transaction where the user is requested to enter his PIN, for example, when paying with a credit card at a merchant 20 and the credit card machine requires a PIN (at times as an addition to a signature) or when the user wishes to withdraw funds from an Automated Teller Machine (ATM) or the like.

Although the invention has been described in detail, nevertheless changes and modifications, which do not depart from the teachings of the present invention, will be evident to those skilled in the art. Such changes and modifications are deemed to come within the purview of the present invention and the appended claims.

It will be readily apparent that the various methods and algorithms described herein may be implemented by, e.g., appropriately programmed general purpose computers and computing devices. Typically, a processor (e.g., one or more microprocessors) will receive instructions from a memory or like device, and execute those instructions, thereby performing one or more processes defined by those instructions. Further, programs that implement such methods and algorithms may be stored and transmitted using a variety of media in a number of manners. In some embodiments, hard-wired circuitry or custom hardware may be used in place of, or in combination with, software instructions for implementation of the processes of various embodiments. Thus, embodiments are not limited to any specific combination of hardware and software.

A “processor” means any one or more microprocessors, central processing units (CPUs), computing devices, microcontrollers, digital signal processors, or like devices.

The term “computer-readable medium” refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

The present invention can be configured to work in a network environment including a computer that is in communication, via a communications network, with one or more devices. The computer may communicate with the devices directly or indirectly, via a wired or wireless medium such as the Internet, LAN, WAN or Ethernet, Token Ring, or via any appropriate communications means or combination of communications means. Each of the devices may comprise computers, such as those based on the Intel®, Pentium®, or Centrino™ processor, that are adapted to communicate with the computer. Any number and type of machines may be in communication with the computer.

1. A computing system comprising:
at least one processor; and
at least one memory communicatively coupled to the at least one processor comprising computer-readable instructions that when executed by the at least one processor cause the computing system to implement a method of generating a dynamic code for a credit card, the method comprising:
(i) receiving by a mobile application associated with a credit card, a request to generate a code for the credit card;
(ii) sending the request to generate a dynamic code for the credit card to a code generation server, the request comprising a timestamp and one or more data associated with the credit card;
(iii) sending the dynamic code to the mobile application;
(iv) providing the dynamic code in a transaction performed using the credit card;
(v) sending the transaction details including the dynamic code for authorization to the financial institution associated with the credit card;
(vi) sending the dynamic code by said financial institution to the code generation server for authentication;
(vii) responsively confirming the dynamic code by the code generation server if the dynamic code is the dynamic code associated with the credit card.

2. The computing system of claim 1, wherein the code is a Card Verification Value (CVV) code.

3. The computing system of claim 1, wherein the code is a Personal Identification Number (PIN) code.

4. A computing system comprising:
at least one processor; and
at least one memory communicatively coupled to the at least one processor comprising computer-readable instructions that when executed by the at least one processor cause the computing system to implement a method of generating a dynamic CVV or PIN code for a transaction card, the method comprising:
(i) receiving a timestamp;
(ii) receiving an initial code and personal data related to said transaction card and/or the user of said transaction card;
(iii) calculating a secret key based on a predefined formula receiving as input the initial code, timestamp and personal data;
(iv) performing a first statistical manipulation on the secret key based on the digits of the secret key (alphabet), the probability of occurrence of each digit in the secret key, the digits of the initial code and reordering the alphabet accordingly;
(v) performing a second statistical manipulation based on selecting a digit from the alphabet and partitioning an interval of the value of said digit, to sub-intervals based on the probabilities of occurrence of the digits in the reordered alphabet;
(vi) performing a third statistical manipulation based on selecting a digit from the alphabet and partitioning the corresponding interval of said digit previously calculated, to sub-intervals based on the probabilities of occurrence of the digits in the reordered alphabet;
(vii) repeating step (vi) for a predetermined number of times; and
(viii) selecting a number from the last calculated interval as the dynamic CVV or PIN code.

5. The computing system of claim 1, wherein the computing system is implemented on a mobile telephone.

6. The computing system of claim 1, wherein the computing system is implemented on a personal computer.

7. The computing system of claim 1, wherein the initial code is the transaction card's static CVV or PIN code.

8. The computing system of claim 1, wherein the timestamp has 16 digits.

9. The computing system of claim 1, wherein the dynamic CVV or PIN is any number in the last calculated interval.

10. The computing system of claim 1, wherein the dynamic CVV or PIN is a predefined number in the last calculated interval (i.e. first, last, half, X %, random).

11. The computing system of claim 1, wherein step (vi) is repeated in correlation with the number of digits in the initial code.

12. The computing system of claim 1, further comprising the step of sending an authentication server the generated CVV or PIN and the timestamp, so the authentication can perform the same calculation as in claim 1 to authenticate the dynamic CVV or PIN.

13. A computing system comprising:
at least one processor; and
at least one memory communicatively coupled to the at least one processor comprising computer-readable instructions that when executed by the at least one processor cause the computing system to implement a method of generating a dynamic Card Verification Value (CVV) or PIN code for a transaction card, the method comprising:
(i) receiving a timestamp;
(ii) receiving an initial code and personal data related to said transaction card and/or the user of said transaction card;
(iii) calculating a secret key based on a predefined formula receiving as input the initial code, timestamp and personal data;
(iv) performing a first statistical manipulation on the secret key based on the digits of the secret key (alphabet), the probability of occurrence of each digit in the secret key, the digits of the initial code and reordering the alphabet accordingly;
(v) performing a second statistical manipulation based on selecting a digit from the alphabet and partitioning an interval of the value of said digit, to sub-intervals based on the probabilities of occurrence of the digits in the reordered alphabet;
(vi) performing a third statistical manipulation based on selecting a digit from the alphabet and partitioning the corresponding interval of said digit previously calculated, to sub-intervals based on the probabilities of occurrence of the digits in the reordered alphabet;
(vii) repeating step (vi) for a predetermined number of times; and
(viii) selecting a number from the last calculated interval as the dynamic CVV code or PIN;
(ix) sending the timestamp and dynamic CVV or PIN code to an authentication server; and
(x) having the authentication server calculate independently a server dynamic CVV or PIN based the received timestamp and personal data, and authenticate the received dynamic CVV or PIN only if matching the received dynamic CVV or PIN.

14. The computing system of claim 10, wherein the authentication server authenticates a credit card transaction.
